(19) United States
(12) Patent Application Publication
(10) Pub. No.: US 2004/0081725 A1
(43) Pub. Date: Apr. 29, 2004

(54) Fat-protein encapsulation and protein fractionation

(76) Inventor: John H. Lee, Olathe, KS (US)

Correspondence Address: John H. Lee, 1441 N Lucy Montgomery Way, Olathe, KS, 66061, US

(21) Appl. No.: 10/278,099

(22) Filed: Oct. 23, 2002

(51) Int. Cl. A23L 1/31

(52) U.S. Cl. 426/92; 426/656

(57) ABSTRACT

A method for preparation of encapsulated fat products with animal blood protein ingredients and then changing the intense dark color into a light color is provided. Animal blood proteins have good capacity to encapsulate fat. But the major issue is the intense dark color. The novel process in this invention overcomes the problem and provides a process method to produce fat and animal blood protein encapsulated products with yellowish color, mild smell, low micro counts, and high material recovery. The encapsulated fat products have no oily characteristics. The encapsulated fat products can be produced into solid or powder form. Another embodiment in this invention provides a process method to separate animal or plant proteins into two functional products, which can be used for different applications according to their functions. The liquid fraction can be further concentrated by an ultrafiltration process easily for reducing the dying cost. The protein products can also be used for fat-protein encapsulation. This separation process can be used to recover more proteins as protein precipitates without damage the protein functions. The novel processes in the invention are feasible for commercial production.

### OTHER REFERENCES

Reference Cited:
U.S. Patent Documents

| | | | |
|---|---|---|---|
| 4098780 | July, 1978 | Lindroos et al. | 260/112 |
| 4138505 | Feb., 1979 | Hart et al. | 426/98 |
| 4180592 | Dec., 1979 | Buckley et al. | 426/32 |
| 4216234 | Aug., 1980 | Rawlings et al. | 426/98 |
| 4217370 | Aug., 1980 | Rawlings et al. | 426/98 |
| 4276140 | June, 1981 | Jain | 204/527 |
| 4330463 | May, 1982 | Luijerink | 260/112 |
| 4486282 | Dec., 1984 | Bier | 204/529 |
| 4808429 | Feb., 1989 | Freeman | 426/647 |
| 5043427 | Aug., 1991 | Leberre et al. | 530/370 |
| 5087695 | Feb., 1992 | McAuley | 424/177.1 |
| 5108908 | April, 1992 | Coves et al. | 435/68 |
| 5138034 | Aug., 1992 | Uemura et al. | 530/413 |
| 5151500 | Sept., 1992 | Wismer-Pedersen et al. | 530/385 |
| 5496572 | Mar., 1996 | Rudden | 426/74 |
| 5514388 | May, 1996 | Rohwer | 426/231 |
| 5874102 | Feb., 1999 | LaJoie et al. | 424/438 |
| 5880266 | March, 1999 | De Buyser et al. | 530/385 |
| 6093324 | July, 2000 | Bertoloni et al. | 210/635 |
| 6229031 | May, 2001 | Strohmaier et al. | 554/156 |
| 6281336 | August 2001 | Laursen et al. | 530/390.1 |
| 6312755 | Nov., 2001 | Wu | 426/656 |
| 6368657 | April, 2002 | Lee | 426/658 |

Foraign Patent Documents

| | | |
|---|---|---|
| 0460219 | Dec., 1991 | EP |
| 2222065 | Feb., 1990 | GB |
| 54026961 | Feb., 1979 | JP |
| 61108000 | May, 1985 | JP |

A. Ballabriga, “Immunity of the Infantile Gastrointestinal Tract and Implication in Modern Infant Feeding”, Acta Paediatr. Jpn. 1982, 24, 53.

D. Gaillard, G. Ailhaud and R. Negrel, “Fetuin Modulates Growth and Differentiation of Ob17 Preadipose Cells in Serum-Free Hormone-Supplemented Medium”, Biophys. Acta. 1985, 846, 185.

A. B. Hoerlein, “The influence of Colostrum on Antibody Response in Baby Pigs”, J. Immunol. 1957, 78, 112.

H. W. Ockerman and C. L. Hansen, “Animal By-Product Processing & Utilization”, Technomic Publishing Company, Inc., 2000.

### BACKGROUND OF THE INVENTION

Animal blood protein products are very good sources of proteins, which contain about 85% crude protein on a solid basis. Whole animal blood contains red blood cells and plasma. Red blood cell contains about 92% protein and plasma contains about 78% protein on a solid basis. Plasma has a light color and is separated from red blood cells by a centrifugation process. Animal blood products with red blood cells have limited applications in the formulation of food, milk replacer, feed, pet food and other products. A major issue is the intense dark color.

Milk whey protein products are often used to encapsulate fat into dry fat products for food and feed applications such as baby formula and animal milk replacer. People prefer the cream color and high digestibility. It has been found animal blood products from whole blood, red blood cells and plasma have very good capacity to encapsulate fat. The fat ingredients are from animal and vegetable sources. But the intense dark color from animal whole blood and red blood cells is a problem.

Over the years, various attempts have been made to make fat encapsulated products. A number of patents have been issued to make the encapsulated fat-protein products. U.S. Pat. No. 6,368,657 discloses a method for preparing the fat-protein products with animal blood and the fat sludge from dissolved air flotation units. But the products still have the intense reddish dark color. U.S. Pat. No. 6,229,031 discloses a method for preparation of fatty acid calcium salt products with calcium oxide at very high pH such as 11. The calcium soap salt products have bypass function for ruminant animals to produce more milk. The soap smell is a concern. U.S. Pat. No. 5,874,102 discloses a method for a dietary fatty acid salt product in granulated form with a polymeric coating. U.S. Pat. No. 5,514,388 discloses a process to treat protein with a base to increase the pH to such as 11 at first. Then the fat is added into the alkali protein. The protein firm gel is formed when the pH is lowed to 3 to 5. U.S. Pat. No. 5,496,572 discloses a process to form a ruminant feed stuff by a homogeneous mixture of animal or vegetable protein nutritional material, one or more fatty acids, and a calcium or magnesium compound by an extrusion process. U.S. Pat. No. 4,808,429 discloses a process to encapsulate animal blood and fat by heating to a temperature in the range 40-45 degree C. and homogenizing into a dispersion or emulsion. Then the mixture was allowed to cool and to form a gel. The gel still has the intense reddish dark color. U.S. Pat. No. 4,217,370 discloses a process to treat protein with a base to increase the pH to such as 11. Then the fat is added into the alkali protein. The protein and fat are mixed together before any pH change. The protein gel is formed when the pH is lowed to the isoelectric point. U.S. Pat. No. 4,216,234 discloses a process to render a proteinaceous medium with strongly alkaline such as 11.5 prior to the formation of the fat dispersion or emulsion, and thereafter the dispersion or emulsion is heated to form a gel. U.S. Pat. No. 4,138,505 discloses a process to heat animal blood to a temperature in the range of from about 20° C. to 60° C., to adjust the pH of the heated aqueous medium to a level ranging from 9 to about 13 to form a blood solid gel, and thereafter recovering the fat-protein gel. The calcium soap salt products from fatty acids and calcium have the soap taste, which is a problem. In pH change treatments, ash level can be increased significantly in the final products because of strong base and acid involved in the processes. The formed gel products by pH change are not easily controlled because of the high viscosity. It is important to scale up processes into products by commercial production.

Various attempts have also been made to remove the intense color from animal blood products over the years. U.S. Pat. No. 5,880,266 discloses a process for removing the heme group from the globin fraction by water dilution, pH change, ultrafiltration and pH reverse. U.S. Pat. No. 5,151,500 discloses a decolorization process by treating blood to low pH. The iron is removed by centrifugation process. Then the supernatant is treated with an oxidizing agent for the decolorization. There is a protein loss after the process. U.S. Pat. No. 5,108,908 discloses a decolorization process by treating blood to low pH. The iron is removed by centrifugation process. U.S. Pat. No. 4,330,463 discloses a process to remove the heme from animal red blood cell by solvent extraction with the organic solvents such as methanol/ethanol/water mixture, recovering the blood cell protein isolate from the extraction residue. U.S. Pat. No. 4,180,592 discloses a decolorization process by a reversal pH or heat and an excess oxidizing agent after which the excess oxidizing agent is removed by adding additional amount of blood. The product color is still dark. U.S. Pat. No. 4,098,780 discloses a method of separating iron compounds from protein, mainly globin, with ethanol, pH change and centrifuge processes. European Patent 0 460 219 discloses a process by treating washed animal red blood cells under alkaline conditions and treating the resulting product under oxidizing conditions. These patents can be used for the decolorization of animal blood products. However the processes involve several process steps such as heme removal and centrifuge processes. The heme by-product with the intense color is another major issue. Also these patents for removing the intense color do not apply the processes to fat and animal blood protein encapsulated products. There is a need for an inexpensive and practical process by which animal blood can be decolorized to yield products having high protein recovery and light color.

The current invention provides a novel process to combine fat-protein encapsulation and color removal together. Animal blood products have very good capacity to encapsulate fat products. Further the intense color of the encapsulated products can be changed into a light color by a decolorized process. The surface color of the product is changed with a very low level peroxide. The practical process can be feasibly scaled up into commercial production to make the encapsulated fat products with animal blood products to form fat-protein products. Besides above benefits, the products also have mild smell, low micro counts, and high material recovery. The encapsulated fat products can be used as food and feed ingredients. For ruminant animals, the encapsulated products may have the by-pass function for more milk production at lower cost.

Another embodiment is to separate animal plasma or serum into two functional products—albumin fraction and immunoglobulin fraction by an one-stage process. Albumin has gel properties, which can be used as a binding and gelling agent for sausage, non-toxic glue and cooked pet foods, and as pelleting agent, and stabilizer. Albumin fraction, which also has other proteins such as fibrinogen, fibrin, apolipoproteins, Vitamin D-binding protein, clot polymers, antithrombin III, hemopexin, retinol binding protein and transthyretin, can be also used for fat-protein encapsulation. Albumin is often used as a protein standard in protein tests. High pure albumin may be processed from the albumin fraction with the process method described in this invention. Immunoglobulins have the biological function due to a passive immunity. Antibodies are made from immunoglobulins. For example weaning piglets fed animal blood immunoglobulin had a faster daily weight gain, lower incidence of scours, and reduced mortality (Gaillard et al., 1985 and Hoerlein et al., 1957). In humans, the importance of immunoglobulins from cow colostrum in infant feeding was proven by clinical test results (Ballabriga, 1982). Immunoglobulin fraction is an ideal ingredient as a passive immunity agent for milk replacer products. The separation process can be also used for fractionating soy, whey, milk, yeast, rice, and egg proteins with the same food or feed grade chemical and for covering more protein and reducing processing cost by the precipitation process. Egg albumen is a viscous liquid at solid 11%, which contains proteins about 10.2%, lipid 0.03%, carbohydrate 0.7% and ash 0.5%. The drying cost is high because of the high moisture level 89% in egg albumen. The viscous liquid can not be processed to increase solid level by a process such as ultrafiltration process. The protein fractionation process in this invention can be used to separate egg albumen into a solid fraction and liquid fraction. Additional heat treatment may also be used to cover more proteins. The solid fraction contains ovalbumin, ovomucoid, G sub2 globulin, ovomacroglobulin, and minor proteins. Ovalbumin is a major protein, which is 54%, in egg albumen. The liquid fraction has low viscosity, which is much clear than egg albumen. The liquid fraction can be further processed with a concentration process such as ultrafiltration process to increase the solid level. The major whey proteins such as lactoglobulin and lactaalbumin may also be precipitated during treating milk to pH about 4. For casein, the new process may increase the yield for cheese or casein process and change some properties. For soy protein concentrate, the process may increase the protein yield into the precipitates.

Protein fractionation processes have been developed over the years. U.S. Pat. No. 6,312,755 discloses a process for achieving high concentration of whey alpha-lactalbumin with an acid to lower the pH of the whey protein product to 4.0 or below. U.S. Pat. No. 6,281,336 discloses a process for producing immunoglobulins from a plasma protein fraction with the anion exchange chromatography and cation exchange chromatography. U.S. Pat. No. 6,093,324 discloses a process for recovering immunoglobulin fraction from plasma on a macroporous anion exchange resin. U.S. Pat. No. 5,138,034 discloses a process for fractionating plasma proteins with 5-10% ethanol, anion exchanger, affinity chromatography, and 18-45% ethanol treatments. Pat. No. 5,087,695 discloses a process to produce a precipitate rich in immunoglobulins by contacting diluted serum with the chemical CuSOsub4. U.S. Pat. No. 5,043,427 discloses a process for fractionating animal proteins with a fatty acid of 6 to 14 carbon atoms such as carprylic acid under controlled pH and temperature. U.S. Pat. No. 4,486,282 discloses a process to precipitate plasma proteins with heavy metal ions and then to do a desalt treatment with electrodialysis. U.S. Pat. No. 4,276,140 discloses a process for fractionating protein mixtures with electrodialysis. Normal two processes for protein fractionations are with ammonium sulfate and cold ethanol (Ockerman and Hansen, 2000).

Above process methods have problems in the disposal of solvent, removal of high salt, and high cost. The separation process in this invention provides an inexpensive and practical process for protein fractionations of plasma, serum, soy, milk, rice, egg, whey and other protein products for covering more protein into the precipitates compared with the above separation process methods.

### SUMMARY OF THE INVENTION

The present invention overcomes the problems of other patents and provides a novel process to make fat-protein encapsulated products with animal blood products by heat and decolorized treatments. Also the present invention provides a practical process to separate proteins for plasma, serum soy, milk, and whey. The two functional products—albumin fraction and immunoglobulin fraction are processed by the one-stage process. Albumin fraction can also be used for fat-protein encapsulation. The objective of the present invention is to provide the process methods, which are convenient and economical to use.

The protein source for fat-protein encapsulation is from animal blood products such as whole blood, red blood cells, plasma, serum, and albumin fraction from such as pork, bovine, poultry, goat, rabbit, and other animals. The fat source is from vegetable oil and animal fat products, fatty acid oil products, and byproducts and waste products from fat or oil processes in food, feed, and chemical industries. Animal blood products have very good capacity to encapsulate fat ingredients to form encapsulated gel products.

A fat ingredient is mixed with an animal blood ingredient. Then a heat source is applied to heat the mixture to a temperature above 55 degree C. to form a fat-protein encapsulated gel product. After the fat-protein encapsulated product is formed, the intense color of the encapsulated product is improved into a light color by a decolorized process with a peroxide such as hydrogen peroxide, sodium peroxide, and calcium peroxide. The product color is changed into a yellowish color with a low level peroxide such as 0.18%. The peroxide may react on the surface of the product for the color change, which will not damage the encapsulated fat. Also the product has low micro counts and mild smell. A homogenizer or high speed pump may be used to make the wet fat-protein encapsulated product into a homogenous form during the process. Then the product may be dried with a spray dryer. The product is in a powder form. The wet fat-protein encapsulated product may also be blended with whey protein and fat encapsulated product together. Besides homogenizer, the process may be applied with a centrifuge or screen process. The moisture can be removed from the wet solid. Then the wet solid may be dried with a general dryer. The fat-protein encapsulated product has no oily physical characteristics even the fat level is at such as 55% in the product on a solid basis. The drying cost is a major cost in the whole process, which can be reduced significantly because the moisture can be removed by mechanical methods such as centrifuge, screen and filtration processes. Either wet or dried product can be used for different applications.

Liquid Animal plasma or serum is mixed with a water soluble polyphosphate, which has the phosphorus number more than 10 and less than 80 in its molecular formula, at a level from 0.01% to 4.5% on a weight basis. The polyphosphate is a food-grade or feed-grade chemical, which can be liquid or solid form. Then the pH is adjusted to a range from 3 to 5.5. A centrifuge process is then used to separate the solid and liquid into two fractions—albumin fraction and immunoglobulin fraction. Albumin fraction is in the solid phase. Immunoglobulin fraction is in the liquid phase. The clear solution of immunoglobulin fraction can be further concentrated to a higher solid level by an ultrafiltration process to reduce drying cost after the pH is changed to above 5.5. Normal animal plasma has some gelling problem, which affect the ultrafiltration process. The solid is often 15% to 20% after the ultrafiltration process. The spray dry process is a high cost process, in which 75% to 80% of moisture must be removed without any value. The solid level of immunoglobulin fraction can be improved by the further ultrafiltration process in this invention, which reduces the spray drying cost. Spray dry is the most expensive drying process. The albumin fraction can be used for different applications such as fat-protein encapsulation, cooked pet foods, non-toxic glue, and binding and gelling purposes. The two products have their own functions and applications. The values of the two products can be increased by the added-value process in this invention. Liquid egg albumen is adjusted to pH 4 to 5 and mixed with the water soluble polyphosphate, which has the phosphorus number more than 10 and less than 80 in its molecular formula, at a level from 0.01% to 4.5% on a weight basis. The polyphosphate is a food-grade or feed-grade chemical, which can be liquid or solid form. Then the pH is adjusted to a range from 3 to 5. Additional heat treatment may be applied to cover more proteins. A centrifuge process is then used to separate the solid and liquid into two fractions. The solid fraction is a strong pellet form with a nice white cream color. The liquid fraction is low viscous solution. A liquid whey protein product, which is from a milk process, is mixed with the water soluble polyphosphate, which has the phosphorus number more than 10 and less than 80 in its molecular formula, at a level from 0.01% to 4.5% on a weight basis. Then the pH is adjusted to a range from 4 to 5. Additional heat treatment may be applied to cover more proteins. A centrifuge process is then used to separate the solid and liquid into two fractions. The solid fraction contains the major whey proteins such as lactoglobulin and lactaalbumin, albumin, and lactoglobulin in the precipitates. The liquid whey fraction may contain less lactaalbumin, albumin, and lactoglobulin and more immunoglobulin and lactaferrin, which may have good health function as a health supplement. Whey lactaalbumin, albumin, and lactoglobulin can be covered from liquid whey with this process method. Also soy, rice and other proteins in liquid form may be mixed with the water soluble polyphosphate at a level from 0.01% to 5% on a weight basis. Then the pH is adjusted to a range from 3 to 5. A centrifuge or filtration process is then used to separate the solid and liquid into two fractions. The process may increase the yield for the protein recovery into the protein precipitates. The protein liquid can be concentrated by an ultrafiltration process easily. When pH is not less than 3, there is no recognized damage to protein functions by pH factor.

The present novel encapsulated fat-protein and protein fractionation processes are practical and economic, which can be feasible into commercial production.

### DETAIL DESCRIPTION OF THE PREFERRED EMBODIMENTS

The following examples set forth preferred methods in accordance with the invention. It is to be understood, however, that these examples are provided by way of illustration and nothing therein should be taken as a limitation upon the overall scope of the invention.

### EXAMPLE 1

Liquid bovine plasma (300 grams) was mixed with sodium polyphosphate (1.8 grams). The mixture was adjusted to a precipitation point with 30% hydrochloric acid and mixed for 15 minutes. Then the solid and liquid mixture was centrifuged into solid and liquid products. Then total protein and immunoglobulin G were measured after the pH was adjusted to 6.8 for the two fraction products. For immunoglobulin fraction, the remained immunoglobulin G was 80.1%. The rate of immunoglobulin G against total protein was 35.1% in the immunoglobulin fraction. The rate of immunoglobulin G against total protein was 6.6% in the albumin fraction. The rate of immunoglobulin G against total protein was 17.4% in the starting material plasma.

### EXAMPLE 2

Soybean oil byproduct—soy soap stock (67 grams at 50% solid) was mixed with pork whole blood (180 ml). The pH was 7.1. The mixture was heated and mixed at high speed. The mixture was heated to 67 degree C. for 8 minutes. Hydrogen peroxide (2.75 ml of 30% concentration) was added slowly at 0.33% level. The mixture was mixed at the speed for 5 minutes. A uniform gel liquid was formed with yellowish color and mild smell. The analytical data were: solid (28.5%), fat (12.5%), protein (11.3%), standard plate counts (300 cfu/g), and Salmonella (negative).

### EXAMPLE 3

Chicken fat sludge from a dissolved air flotation unit (100 grams at solid 20%) was mixed with liquid bovine red blood cells (65 grams). The mixture was mixed and heated to 87° C. with a mixer for 1 minute. Hydrogen peroxide (1.0 ml of 30% concentration) was added at 0.18% level. The product with yellowish color was screened and pressed to remove the extra water. The solid was dried in an oven at 105 degree C. for 5 hours. The analytical data were as follows: fat (42.1%), protein (48.5%), moisture (3.8%), ash (2.8%), plate count (100 cfu/g), and Salmonella (negative). The fat-protein encapsulated product had no oily physical characteristics.

### EXAMPLE 4

Liquid egg albumen (150 grams) was adjusted to pH 4.5 with 30% hydrochloric acid and mixed with sodium polyphosphate (1.0 grams). The mixture was adjusted to a precipitation point with 30% hydrochloric acid. Then the solid and liquid mixture was centrifuged into solid and liquid products. The liquid was low viscous solution. The solid was in a pellet form with white cream color with a solid level 25.6% and protein 21.7%.

### EXAMPLE 5

Liquid pork plasma (200 grams) was mixed with calcium chloride (0.2 grams) and liquid sodium polyphosphate (3.6 grams at 50% solution). The mixture was adjusted to a precipitation point with 30% hydrochloric acid. Then the solid and liquid mixture was centrifuged into solid and liquid products. Then total protein and immunoglobulin G were measured after the pH was adjusted to 7.0 with 25% sodium hydroxide for the two fraction products. The remained immunoglobulin G in the immunoglobulin fraction was 87.7%. The rate of immunoglobulin G against total protein in the immunoglobulin fraction was 31.2%. The rate of immunoglobulin G against total protein in the starting material plasma was 16.5%.

### EXAMPLE 6

Liquid pork albumin fraction (200 grams from Example 5), crude coconut oil (45 grams) and soy lecithin (0.3 grams) was mixed. The mixture was heated and mixed at high speed. The mixture was heated to 78 degree C. A uniform gel liquid was formed with a light color. The analytical data were: solid (34.3%), fat (17.5%) and protein (13.6%).

### EXAMPLE 7

Liquid whey protein product from a milk process (150 grams) was mixed with sodium polyphosphate (0.8 grams). The mixture was adjusted to a precipitation point with 30% hydrochloric acid. Then the solid and liquid mixture was centrifuged into solid and liquid products. The solid was in a pellet form with white cream color. The liquid was clear solution.

### EXAMPLE 8

Liquid whey protein concentrate (69 grams), wet bovine albumin fraction solid (30 grams from Example 1), soy lecithin (0.2 grams), and pork fat (20 grams) were mixed. The pH of the mixture was 4.5 and was adjusted to 6.7 with 25% sodium hydroxide. The mixture was heated and mixed at high speed. The mixture was heated to 75 degree C. A uniform gel liquid was formed with a light color. The analytical data were: solid (32.7%), fat (17.3%) and protein (4.6%). Above liquid product was dried in an oven at 105 degree C. for 5 hours. The analytical data of the dry product were: fat (53.1%), protein (13.8%), and moisture (5.1%). The fat-protein encapsulated product had no oily physical characteristics on the product surface.

### EXAMPLE 9

Soy milk (100 grams) was mixed with sodium polyphosphate (0.7 grams) at pH 6.5. The mixture was adjusted to a precipitation point with 30% hydrochloric acid. Then the solid and liquid mixture was centrifuged into solid and liquid products. Another 100 grams of soy milk was also processed without sodium polyphosphate. The protein solid recovery was 13.8% more for the process with sodium polyphosphate than the control process without sodium polyphosphate.

### EXAMPLE 10

Pork fat waste product (105 grams at 18% solid and 11% fat) and pork red blood cells (60 grams) was mixed. The mixture was heated to 89° C. with a mixer for 1 minute. Hydrogen peroxide (1.0 ml of 30% concentration) was added at 0.18% level. The product with yellowish color was centrifuged. The water was removed. The solid was dried in an oven at 105 degree C. for 5 hours. The analytical data were as follows: fat (38.8%), protein (49.2%), moisture (5.1%), ash (3.2%), plate count (100 cfu/g), and Salmonella (negative). The fat-protein encapsulated product had no oily physical characteristics on the product.

What is claimed is:

1. A method of preparing a fat and animal blood protein encapsulated product comprising mixing a fat ingredient with a animal blood protein ingredient and then heating the mixture to a temperature above 55 degree C. to form an fat-protein encapsulated gel product and then adding a peroxide to change the intense dark color.

2. The method of claim 1 wherein the animal blood protein ingredient is from animal whole blood, red blood cells, plasma and plasma protein fractions.

3. The method of claim 1 wherein the fat ingredient is from vegetable oil and animal fat products, fatty acid oil products, and their byproducts and waste products from fat and oil processes.

4. The method of claim 1 wherein the peroxide is from hydrogen peroxide, sodium peroxide and calcium peroxide at 0 to 3.5% on a weight basis.

5. The method of claim 1 wherein one or more fat ingredients and one or more protein ingredients are used to make the fat-protein encapsulated products.

6. The method of claim 1 wherein a homoginizer or high-speed mixer is used to make the encapsulated fat-protein product in a homogenous form for making the powder product by a spray drying process.

7. The method of claim 1 wherein the fat and animal blood protein encapsulated product is wet or dry form with fat level from 15% to 85% on a solid basis.

8. A method of preparing animal plasma or serum proteins into two functional protein products of albumin fraction and immunoglobulin fraction comprising mixing a polyphosphate into liquid animal plasma or serum, applying a centrifuge or filtration process to separate the solid and liquid products at pH from 3 to 5.5 and then concentrating immunoglobulin fraction by an ultrafiltration process.

9. The method of claim 8 wherein the polyphosphate is water soluble and is used at from 0.01% to 4.5% on a weight basis into liquid animal plasma or serum.

10. The method of claim 8 wherein the albumin fraction product is used for applications of binding and gelling purposes, non-toxic glue, nutrition, and fat-protein encapsulation.

11. The method of claim 8 wherein the immunoglobulin fraction is a clear solution at pH above 5.5 and is further processed by an ultrafiltration process to increase solid level and to decrease the drying cost.

12. The method of claim 8 wherein the immunoglobulin fraction product is used as a nutritional ingredient.

13. The method of claim 8 wherein the two protein products are wet or dry form.

14. A method of preparing protein fractions for fractionating liquid soy, rice, yeast, egg, milk, and whey proteins by a precipitation process comprising mixing a polyphosphate into the liquid protein product, applying a centrifuge or filtration process to separate the solid and liquid products at pH from 2.5 to 5.5 and then concentrating the liquid fraction by an ultrafiltration or evaporation process.

15. The method of claim 14 wherein the polyphosphate is water soluble and is used at from 0.01% to 4.5% on a weight basis into the protein liquid.

16. The method of claim 14 wherein the product is used as a protein ingredient.

17. The method of claim 14 wherein the protein product is wet or dry form.
